(19) United States
(12) Patent Application Publication
(10) Pub. No.: US 2015/0209870 A1
(43) Pub. Date: Jul. 30, 2015

(54) BALANCING OR MEASURING DEVICE

(71) Applicant: Franz Haimer Maschinenbau KG, Igenhausen (DE)

(72) Inventor: Franz Haimer, Igenhausen (DE)

(21) Appl. No.: 14/420,448

(22) PCT Filed: Aug. 9, 2013
(86) PCT No.: PCT/EP2013/066699

§ 371 Date: Feb. 9, 2015

(30) Foreign Application Priority Data
Aug. 9, 2012 (DE) 10 2012 107 331.7

(51) Int. Cl. B23B 31/117; B23B 31/00

(52) U.S. Cl. CPC B23B 31/117; B23B 31/006; B23B 2231/04; B23B 2270/12; B23B 2265/08

(57) ABSTRACT

A balancing or measuring device has a main body which rotates about an axis of rotation and includes an opening for accommodating a coupling shaft of a rotor, and includes a centering element for centering the rotor in the opening. The centering element includes at least one support zone which rests against the coupling shaft and is resilient in the radial direction.

The invention relates to a balancing or measuring device according to the preamble of Claim 1 and to a balancing and measuring machine having such a balancing or measuring device.

The balancing or measuring machines used for balancing or measuring tools, tool holders or other types of rotors usually contain a machine spindle driven by a drive motor, an adapter that can be inserted into the machine spindle, or a different main body rotating about a rotational axis and having a centered receiving opening, into which a coupling shaft of the rotor can be inserted axially. The rotor can be tightly clamped with its coupling shaft in the receiving opening of the rotating main body by means of a suitable clamping device. In order to obtain a precise centering of the rotor inside the main body rotating about the axis of rotation, both the receiving opening in the main body and the coupling shaft must be produced extremely precisely. However since the balancing or measuring devices are also intended to be used for tool holders and tools from different manufacturers, and a production of the rotor that is precisely matched to the precision of the receiving opening in the main body is not always guaranteed, linear bushings are used as additional centering elements, for example. These centering elements are susceptible to wear, however, and can leave undesired pressure marks or running tracks on the coupling shaft.

The problem addressed by the invention is that of creating a balancing or measuring device of the type mentioned above and a balancing or measuring machine that are less susceptible to wear and nevertheless are sufficiently stable to guarantee the required accuracy.

This problem is solved by a balancing or measuring device having the features of Claim 1 and by a balancing or measuring machine having the features of Claim 21. Expedient improvements and advantageous embodiments of the invention are the subject matter of the subordinate claims.

The balancing and measuring device according to the invention is distinguished in that the centering element has at least one support region that contacts the coupling shaft and is resiliently elastic in the radial direction. Contrary to the point-wise contact of the balls when a linear bushing is used, a larger pressing surface is made possible by the support region and consequently pressure marks on the coupling shaft are avoided. A more stable centering for concentricity can also be achieved by the large-surface contact. The elastic resilience of the support surface makes it possible to center the coupling shaft already when it is being inserted into the centering element, which guarantees a higher precision and faster clamping. In addition, slight dimensional deviations of the coupling shaft are compensated by the radially resilient support region, and centered clamping is nevertheless possible. Consequently, production tolerances of the coupling shaft can be larger and production costs can be reduced.

In an advantageous embodiment, the centering element is inserted into an annular recess on the upper side of the main body. The centering element is supported over a large surface by the annular recess and is also protected from contamination. Nevertheless, the centering element is also easily accessible and can be quickly mounted or exchanged.

In a particularly advantageous embodiment, the support region is arranged on the inner side of an annular centering element having a C-shaped cross section. A particularly good resilient effect and therefore a high level of elasticity are achieved by the curved, C-shaped design of the support region. Among other things, this allows the use of somewhat harder but wear-resistant materials such as various steels or aluminum alloys.

It is likewise advantageous if the centering element has two support legs spaced apart from one another for bracing on the component. The support legs increase the stability and also offer a precisely adjustable contact surface for exact and reproducible bracing of the centering element on the main body.

In another advantageous embodiment, a plurality of slots spaced apart from one another are arranged in the support region. These slots can be arranged, for example, in the longitudinal direction relative to the axis of rotation of the main body. A different angle is conceivable, however, in order to adjust various properties relating to the elasticity. The number, arrangement and width of the slots can also be varied, which can likewise influence the elasticity and thus the resilient effect.

It is also advantageous if the centering element is formed as a ring and includes a plurality of inner web-like support regions distributed across the periphery and spaced apart from one another for contact with the coupling shaft, and a plurality of outer webs offset relative to the web-like support regions in the circumferential direction for contact with the rotating component. The offset of the inner support regions from the outer support regions achieves a resilient effect of the ring. The coupling shaft can thereby be clamped resiliently, but still centered and precisely.

In another advantageous embodiment, the centering element is integrally formed with the main body. The production and installation expense can thereby be reduced. The support region can be arranged as above on a circumferential annular web that protrudes inwardly. The annular web is formed, for example, by a circumferential annular groove on the upper side of the main body. In addition, continuous slots can be formed on the annular web, by means of which the elasticity and the resilient effect of the centering element can be influenced.

In another advantageous embodiment of the balancing and measuring device, the support region can be formed by a plurality of support segments separated from one another in the circumferential direction. The support segments can be separated from one another by recesses, for example. Due to the fact that the support segments do not contact the entire coupling shaft over the surface thereof, this embodiment is less sensitive to contamination or other foreign bodies in the receptacle and nevertheless allows stable and centered clamping.

In another possible embodiment, the support segments are formed by annular segment-like grooves in the rotating component that are separated from one another in the circumferential direction. This allows simple and cost-effective production, because no additional parts are necessary and the web-like support segments can be directly adapted by the size and arrangement of the annular grooves. The grooves, the annular recess or other cavities can be also filled with an elastic compound, whereby the elastic properties of the support segments can be further influenced and the cleaning effort is also markedly reduced. Slots can also be arranged in the support segment, which again influence the elastic properties.

The centering element can also be designed in the form of a disk spring with a radially inner contact surface for contact on the coupling shaft and a radially outer contact surface for contact on the inner wall of the recess.

The above-described balancing or measuring device is part of a balancing or measuring machine in which the component to be balanced or measured is pulled via the coupling shaft with the aid of a conventional clamping device into the receiving opening of the main body rotating about the axis of rotation and is held there.

Additional details and advantages of the invention emerge from the following description of preferred embodiments with reference to the drawings. In the drawing:

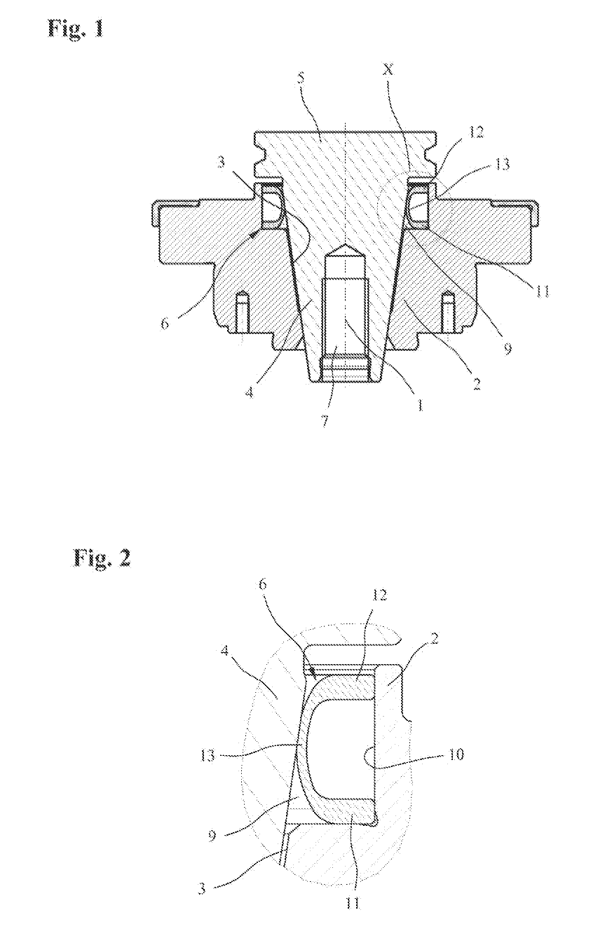

FIG. 1 shows a first embodiment of a balancing or measuring device in cross section;

FIG. 2 shows a detailed view of X from FIG. 1;

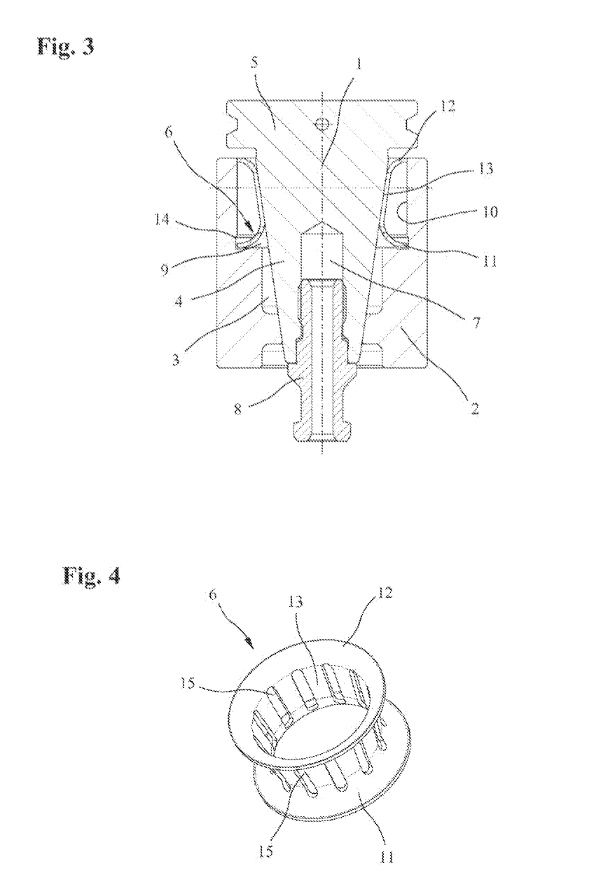

FIG. 3 shows a second embodiment of a balancing or measuring device in cross section;

FIG. 4 shows a centering element of the embodiment from FIG. 3 in a perspective view;

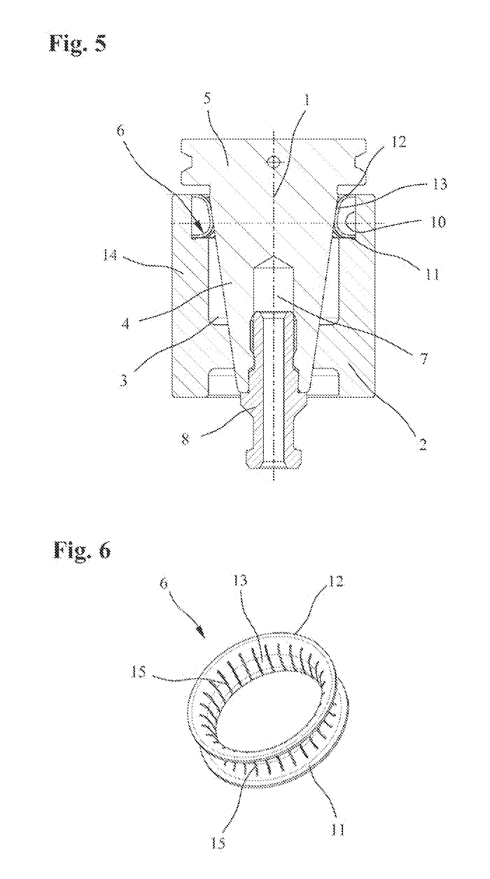

FIG. 5 shows a third embodiment of a balancing or measuring device in cross section;

FIG. 6 shows a centering element of the embodiment from FIG. 3 in a perspective view;

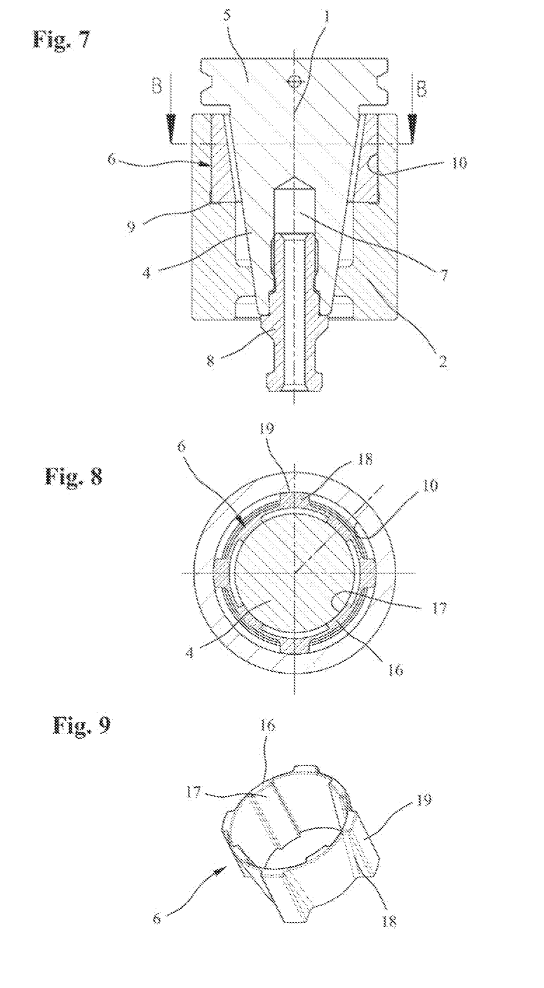

FIG. 7 shows a fourth embodiment of a balancing or measuring device in cross section;

FIG. 8 a sectional view along the line B-B of FIG. 7;

FIG. 9 the centering element of the embodiment from FIG. 7 in a perspective view;

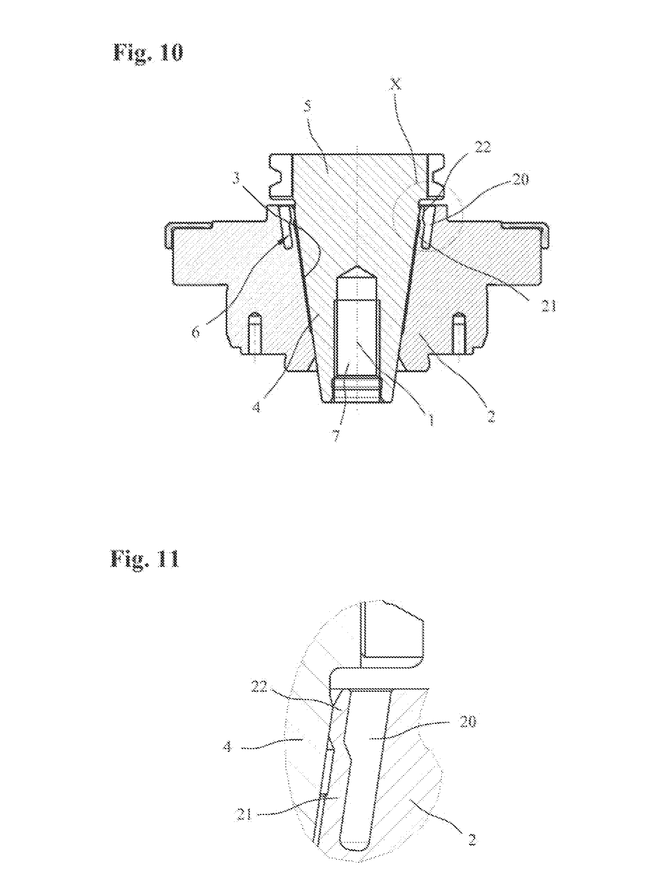

FIG. 10 a fifth embodiment of a balancing or measuring device in cross section;

FIG. 11 shows a detailed view of X from FIG. 10;

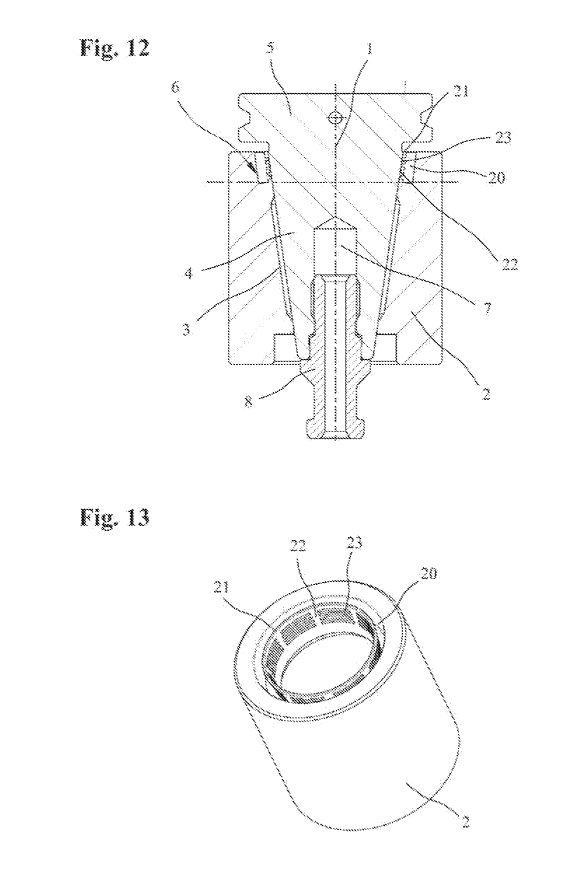

FIG. 12 shows a sixth embodiment of a balancing or measuring device in cross section;

FIG. 13 shows the embodiment from FIG. 12 in a perspective view;

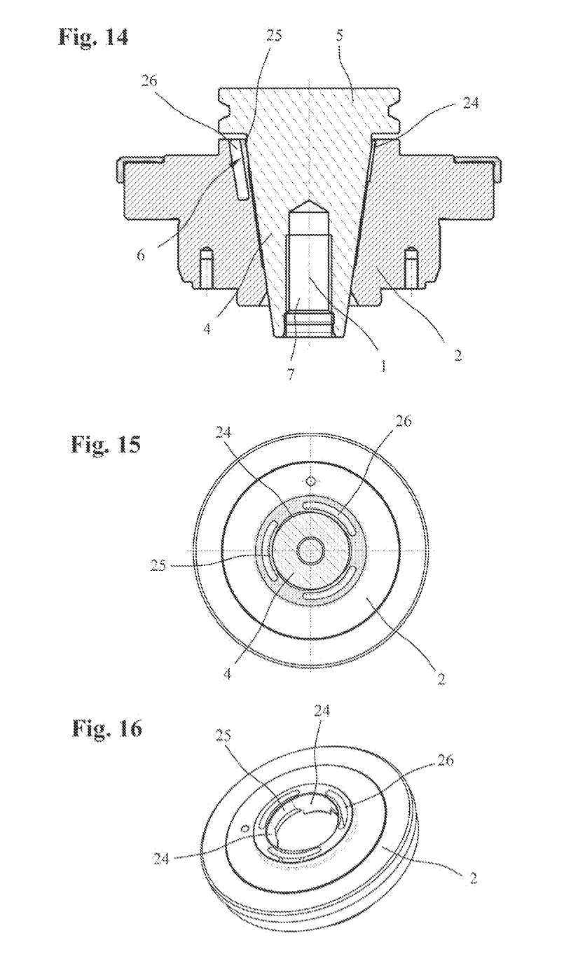

FIG. 14 shows a seventh embodiment of a balancing or measuring device in cross section;

FIG. 15 shows a cross section of the embodiment in FIG. 14;

FIG. 16 shows the embodiment in FIG. 14 in perspective view;

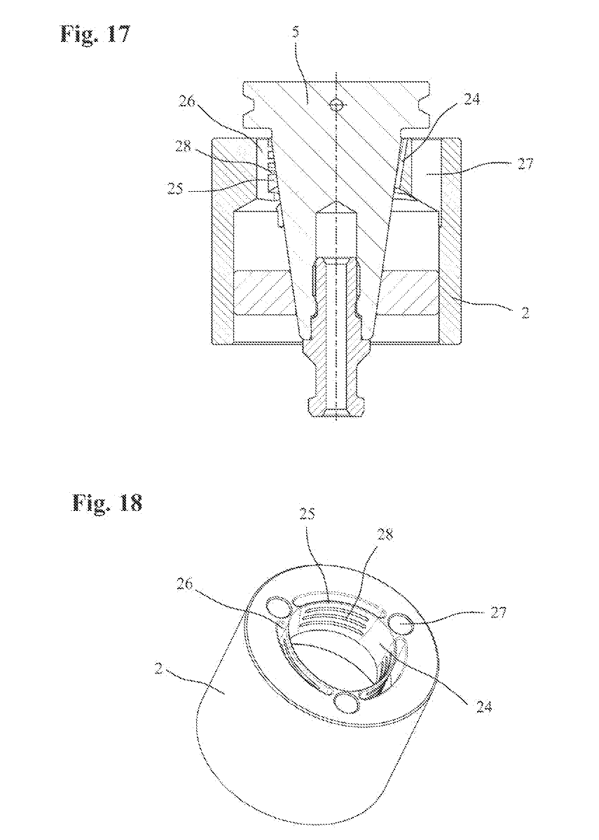

FIG. 17 shows an eighth embodiment of a balancing or measuring device in cross section;

FIG. 18 shows the embodiment in FIG. 17 in perspective view;

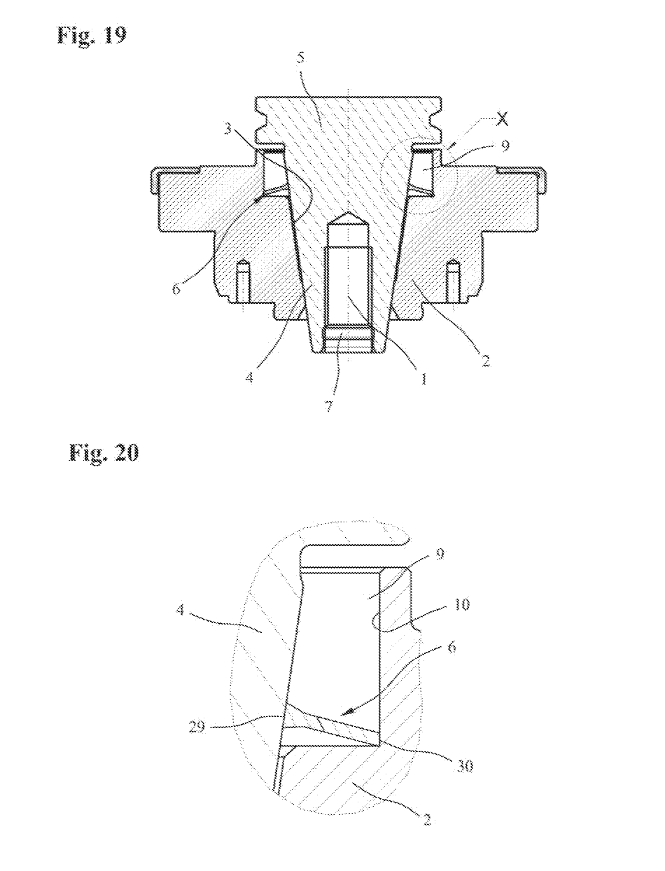

FIG. 19 shows a ninth embodiment of a balancing or measuring device in cross section; and

FIG. 20 shows a detailed view of X from FIG. 19.

FIG. 1 shows a main body 2 rotating about an axis of rotation 1 and having a conical receiving opening 3 for receiving the coupling shaft 4 of a rotor 5. The rotor 5 can be, for example, a tool holder, a tool, or some other component to be balanced or measured. An annular centering element 6 for concentric centering of the tool holder 5 in the main body 2 is arranged inside the receiving opening 3 of the main body 2. The main body 2 and the centering element 6 are parts of a balancing or measuring device that is used in a balancing or measuring machine for balancing or measuring rotating components. In the embodiment shown, the main body 2 is designed as an adapter for mounting on a machine spindle. The balancing or measuring device can thereby be adapted relatively quickly and easily to different types of coupling shafts on tools or tool holders. The main body 2 can also be the motor-driven machine spindle itself, however.

At the lower end of the coupling shaft 4, the rotor 5 contains a threaded hole 7, which is used for screwing in a clamping pin 8 shown in FIG. 3. Via the clamping pin 8 and a clamping device, which is conventional and therefore not shown, the rotor 5 can be pulled with the coupling shaft 4 into the receiving opening 3 of the main body 2 and clamped tightly there.

In the embodiment shown in FIGS. 1 and 2, the centering element 6 is inserted into an annular recess 9 at the upper end of the main body 2. The annular centering element 6 has a C-shaped cross section to support legs 11 and 12 facing an inner wall 10 of the recess 9 and an annular support region 13, slightly bent here, facing the coupling shaft 4 between the two support legs 11 and 12. The annular centering element 6 is supported on the main body 2 via the two parallel support legs 11 and 12 separated from one another. In the embodiment shown, the two support legs 11 and 12 both rest against the inner wall 10 of the annular recess 9. The slightly bent support region 13 on the inner side of the annular centering element 6 is elastically resilient in the radial direction and protrudes slightly inward from the receiving opening when the rotor 5 is not inserted. The centering element 6 can thereby generate a radial pre-tensioning via the inner annular support region 13 in order to center the coupling shaft 4 inside the receiving opening 3 when the shaft is introduced.

As can be seen from FIG. 2, a slight gap is provided between the conical receiving opening 3 of the main body 2 and the coupling shaft 4. This gap, which can be between 0.005 and 0.05 mm, enables a pre-centering of the rotating main body 2 and also limits the excursion of the rotating main body 2, so that the centering element 6 only needs to have a slight elasticity.

In the embodiment shown in FIGS. 3 and 4, the centering element 6 is also designed in the shape of a ring having a C-shaped cross section. The rotating main body 2 is formed here as a sleeve or drive spindle having an upper annular recess 9 for receiving the centering element 6. The centering element 6 likewise contains an annular inner support region 13 and two support legs 11 and 12 facing the inner wall 10 of the recess 9. In contrast to the embodiment of FIGS. 1 and 2, the annular recess 9 has a turned recess 14 at the bottom, so that only the upper support leg 12 contacts the inner wall 10 of the recess. On the contrary, the lower support leg 11 is a short distance away from the inner wall of the turned recess 14. In addition, continuous axial slots 15 separated from one another in the circumferential direction are provided in the annular inner support region 13.

Another embodiment for a separate centering element 6 in the form of a ring having a C-shaped cross section that is inserted into the main body 2 is shown in FIGS. 5 and 6. Here as well, the centering element 6 contains an annular inner support region 13 and two support legs 11 and 12 facing an inner wall 10 of the recess 9. In contrast to the embodiment in FIGS. 3 and 4, there are more and narrower slots 15 introduced in the inner support region 13. In addition, here both the lower support leg 11 and the upper support leg 12 are again supported on the inner wall 10 of the annular recess 9.

FIGS. 7-9 show an additional embodiment having a centering element 6 formed as a ring. In this embodiment, the annular centering element 6 has, on the inside thereof, a plurality of inwardly protruding web-like support regions 16 equidistant angularly from one another in the circumferential direction, the web-like support regions having an inner contact surface 17 for contacting the outer side of the coupling shaft 4. The annular centering element 6 contains, on the outer side thereof, a plurality of outwardly-protruding webs 18 equidistant angularly from one another, which have outer contact surfaces 19 for contacting the inner wall 10 of an annular recess 9 in the main body 2. The outer webs 18 are offset in the circumferential direction relative to the inner web-like support regions, so that regions of the annular centering element 6 between the outer webs 18 are flexible in the radial direction and the inner web-like support regions 16 are elastically resilient in the radial direction.

In the embodiment shown in FIGS. 10 and 11, the centering element 6 is formed integrally with the main body 2 rotating about an axis of rotation 1. An annular web 21, formed by an annular groove 20 and having a support region 22 for contact with the coupling shaft 4, is arranged on the upper side of the rotating main body 2, which is designed as an adapter. The support region 22 is formed protruding inwardly on the radially yielding and elastically resilient upper part of the annular web 21. The support region 22 can also be designed differently, however.

Another embodiment is shown in FIGS. 12 and 13. In this embodiment as well, the centering element 6 is formed integrally with the main body, rotating about an axis of rotation 1. As in the embodiment in FIGS. 10 and 11, an annular web 21, formed by an annular groove 20 and having a support region 22 for contact with the coupling shaft 4, is provided on the upper side of the main body 2, constructed in this case as a sleeve or spindle. In this embodiment, continuous slots 23 running in the circumferential direction are arranged in the annular web 21.

In an embodiment shown in FIGS. 14-16, there is no continuous support region. In this case, the support region of the centering element 6 is formed by a plurality of inwardly protruding support segments 25 in the form of curved webs for contact with the coupling shaft 4, the webs being separated from one another in the circumferential direction by recesses 24. The web-like support segments 25 can be formed, for example, by annular segment-shaped grooves 26 in the rotating component 2 that are spaced apart from one another in the circumferential direction. The support segments 25 thereby yield in the radial direction and form an elastically resilient support region. The grooves 26 can be cast with an elastic compound.

The embodiment shown in FIGS. 17 and 18 substantially corresponds to the embodiment in FIGS. 14-16. In contrast to the previous embodiment, axial bores 27 are arranged between the grooves 26. In addition, continuous slots 28 running in the circumferential direction are arranged in the support segments 25.

Another embodiment is shown in FIGS. 19 and 20. In this embodiment, the centering element 6 is designed in the form of a disk spring having a radially inner contact surface 29 serving as a support surface for contact with the coupling shaft 4 and a radially outer contact surface 30 for contact with the inner wall 10 of the recess 9. The radially inner contact surface 29 is widened in order to prevent pressing marks on the coupling shaft 4 and to guarantee a region with good support. During clamping, the conical coupling 4 shaft first comes into contact with the inner diameter of the disk spring. Due to the shallow angle of attack of the disk spring, it can easily yield with the axial intake movement of the rotor 5 and spreads itself out radially in the process. At the end of the clamping movement, the rotor 5 is supported radially with a relatively high rigidity. The disk spring can be slotted radially in order to reduce its stiffness.

1-21. (canceled)

22. Balancing or measuring device that contains a main body rotating about an axis of rotation, the main body having a receiving opening for receiving a coupling shaft of a rotor and a centering element for centering the rotor in the receiving opening, wherein the centering element has at least one elastically resilient support region contacting the coupling shaft, wherein the centering element contains two support legs at a distance from one another for bracing on the main body that contact an inner wall of the main body.

23. Balancing or measuring device according to claim 22, wherein the centering element is inserted into an annular recess at the upper side of the main body.

24. Balancing or measuring device according to claim 22, wherein the support region is arranged on the inner side of an annular centering element having a C-shaped cross section.

25. Balancing or measuring device according to claim 22, wherein a plurality of slots at a distance from one another are arranged in the support region.

26. Balancing or measuring device that contains a main body rotating about an axis of rotation and having a receiving opening for receiving a coupling shaft of a rotor, and a centering element for centering the rotor in the receiving opening, wherein the centering element has at least one support region that contacts the coupling shaft and is elastically resilient in the radial direction, wherein the centering element is formed as a ring and contains a plurality of support regions for contact with the coupling shaft, which are distributed across the periphery at a distance from one another, and a plurality of outer webs for contact with the main body, which are offset in the circumferential direction relative to the web-like support regions.

27. Balancing or measuring device that contains a main body rotating about an axis of rotation and having a receiving opening for receiving a coupling shaft of a rotor, and a centering element for centering the rotor in the receiving opening, wherein the centering element has at least one support segment that contacts the coupling shaft and is elastically resilient in the radial direction, wherein the support region is formed by a plurality of support segments at a distance from one another in the circumferential direction, wherein the support segments are separated from one another by recesses.

28. Balancing or measuring device according to claim 27, wherein the support segments are formed by grooves in the main body that have the shape of annular segments and are at a distance from one another.

29. Balancing or measuring device according to claim 27, wherein slots are arranged in the support segments.

30. Balancing or measuring device that contains a main body rotating about an axis of rotation and having a receiving opening for receiving a coupling shaft of a rotor, and a centering element for centering the rotor in the receiving opening, wherein the centering element has at least one support segment that contacts the coupling shaft and is elastically resilient in the radial direction, wherein the centering element is in the form of a disk spring having a radially inner contact surface as a support region.

31. Balancing or measuring device according to claim 30, wherein the centering element constructed in the form of a disk spring contains a radially outer contact surface for contact with the main body.

32. Balancing or measuring device according to claim 30, wherein the radially inner contact surface is widened.

33. Balancing or measuring device according to claim 30, wherein the centering element constructed in the form of a disk spring is slotted radially.

34. Balancing or measuring device according to claim 23, wherein the recess or the grooves are filled with an elastic compound.

35. Balancing or measuring device according to claim 22, wherein the centering element is integrally formed with the main body.

36. Balancing or measuring machine having a balancing or measuring device, wherein the balancing or measuring device is constructed according to claim 22.
